(19) United States
(12) Patent Application Publication
(10) Pub. No.: US 2003/0199794 A1
(43) Pub. Date: Oct. 23, 2003

(54) Ultrasonic operating apparatus

(75) Inventors: Tomohisa Sakurai, Sagamihara-shi (JP); Hiroyuki Takahashi, Tokyo (JP)

Correspondence Address: SCULLY SCOTT MURPHY & PRESSER, PC, 400 GARDEN CITY PLAZA, GARDEN CITY, NY, 11530

(73) Assignee: OLYMPUS OPTICAL CO., LTD., TOKYO (JP)

(21) Appl. No.: 10/414,995

(22) Filed: Apr. 16, 2003

(30) Foreign Application Priority Data
Apr. 17, 2002 (JP) 2002-115398

(51) Int. Cl. A61H 1/00

(52) U.S. Cl. 601/2

(57) ABSTRACT

In an ultrasonic operating apparatus, a storage medium which stores characteristic information on an ultrasonic probe is provided in the probe side (in the probe itself or in a dedicated transducer of the probe), and management of driving conditions for the probe and/or the use history of the probe is performed by using the characteristic information. Examples of the characteristic information are identification information and use history information as to the probe. For example, in the case where identification information on a probe is recorded on a recording medium, a control device for driving and controlling the probe determines driving conditions suitable for the probe by using the identification information, and drives an ultrasonic vibrator under the driving conditions. In the case where the use history of the probe is recorded on the recording medium, the control device updates the use history information.

### CROSS-REFERENCE TO RELATED APPLICATION

This application is based upon and claims the benefit of priority from prior Japanese Patent Application No. 2002-115398, filed Apr. 17, 2002, the entire contents of which are incorporated herein by reference.

### BACKGROUND OF THE INVENTION

1. Field of the Invention

The present invention relates to an ultrasonic operating apparatus, and more particularly, to an ultrasonic operating apparatus to which a plurality of probes can be interchangeably attached.

2. Description of the Related Art

In recent years, an ultrasonic operating apparatus using ultrasonic vibration has been developed and put to practical use as a surgical operating apparatus which replaces an electrical scalpel. The ultrasonic operating apparatus using ultrasonic vibration energy has high safety and does not produce smoke during treatment, as compared with the treatments of living tissues with electrical scalpels. Accordingly, the ultrasonic operating apparatus is useful in, for example, endoscopic surgical operation.

The function of this ultrasonic operating apparatus, such as coagulation and incision of living tissue, is chiefly realized by frictional heat due to ultrasonic vibration, so that after the start of an ultrasonic treatment with an ultrasonic therapeutic instrument, it takes time until the action of the ultrasonic treatment appears actually.

In view of this phenomenon, an ultrasonic operating apparatus for improving the efficiency of ultrasonic treatment at the starting time thereof is disclosed in JP-A-9-299381. The ultrasonic operating apparatus disclosed in this publication has a setting switch for setting an ultrasonic output relative to normal running for ultrasonic treatment, and a control circuit for controlling the ultrasonic operating apparatus by changing the running state of it. This control circuit controls the running state, of the ultrasonic apparatus so that the ultrasonic output at the starting time of ultrasonic treatment is made larger than the output value set by the setting switch and, after a predetermined time has passed, the ultrasonic output from the ultrasonic vibrator becomes the output value set by the setting switch. According to this construction, the efficiency of ultrasonic treatment with the ultrasonic operating apparatus is improved.

Driving conditions suitable for such an ultrasonic operating apparatus differ for probes to be attached to the ultrasonic operating apparatus, and it is, therefore, desirable to set driving conditions suitable for individual probes.

In recent years, as the contents of the ultrasonic operating apparatus to be applicable to living tissues become larger in number and the range of treatment with the ultrasonic operating apparatus becomes wider, more kinds of hand pieces each including a therapeutic instrument corresponding to the kind of living tissue to be treated and a probe for transmitting ultrasonic vibration to the therapeutic instrument have been developed and put to practical use. For example, there are hand pieces such as a hook probe which gives treatment while pulling a membranous tissue, a scissors probe capable of incising connected living tissues including a blood vessel with the connected living tissues coagulated in a grasped state, a curve-shaped probe which is improved in the visibility of a therapeutic part, or a spatula-shaped probe capable of peeling a tissue. Furthermore, there is a hand piece improved to be able to be used in endoscopic surgical operation by elongating and thinning a hollow tissue emulsifying probe which has heretofore been used.

In addition, probes which are ultrasonically vibrated are cleaned, sterilized and reused so long as the function and the performance of the ultrasonic operating instrument are not impaired. For this reason, it is desirable to record the use history of each probe on a recording book or the like.

### BRIEF SUMMARY OF THE INVENTION

An ultrasonic operating apparatus according to the invention is constructed so that a storage medium which stores characteristic information on an ultrasonic probe is provided in the probe side (in the probe itself or in a dedicated transducer of the probe), and management of driving conditions for the probe and/or the use history of the probe is performed by using the characteristic information.

Examples of the characteristic information are identification information and use history information as to the probe. For example, in the case where identification information on a probe is recorded on a recording medium, a control device for driving and controlling the probe determines driving conditions suitable for the probe by using the identification information, and drives an ultrasonic vibrator under the driving conditions. In the case where the use history of the probe is recorded on the recording medium, the control device updates the use history information.

Optimum driving conditions for each probe are recorded, for example in a control device in such a manner that the driving conditions of each probe correspond to the respective probe. However, the driving conditions may also be recorded on a device on a network accessible from the control device. Similarly, use history information can also be recorded in the control device or on the device on the network accessible from the control device.

In the case where a probe is to be supplied with cooling water, the amount of supply of cooling water can be controlled by the control device in a manner similar to that used in the ultrasonic driving conditions.

The ultrasonic probe may be provided separately from or integrally with the transducer, and the invention can be applied to either case.

Desirably, information from the recording medium is read in a non-contact manner. For example, radio waves may be used.

### BRIEF DESCRIPTION OF THE SEVERAL VIEWS OF THE DRAWING

These and other features, aspects, and advantages of the apparatus and methods of the present invention will become better understood with regard to the following description, appended claims, and accompanying drawings where:

FIG. 1 is a block diagram showing a preferred construction of an ultrasonic operating apparatus according to a first embodiment of the invention;

FIG. 2 is an exploded perspective view showing the construction of the external appearance of a hand piece of the ultrasonic operating apparatus according to the first embodiment of the invention;

FIG. 3 is a block diagram showing a preferred construction of an ultrasonic operating apparatus according to a second embodiment of the invention;

FIG. 4 is a block diagram showing a preferred construction of a driving control device used in an ultrasonic operating apparatus according to a third embodiment of the invention; and

FIG. 5 is a block diagram showing a preferred construction of an ultrasonic operating apparatus according to a fourth embodiment of the invention.

### DETAILED DESCRIPTION OF THE INVENTION

Preferred embodiments of the present invention will be described hereinafter with reference to the drawings.

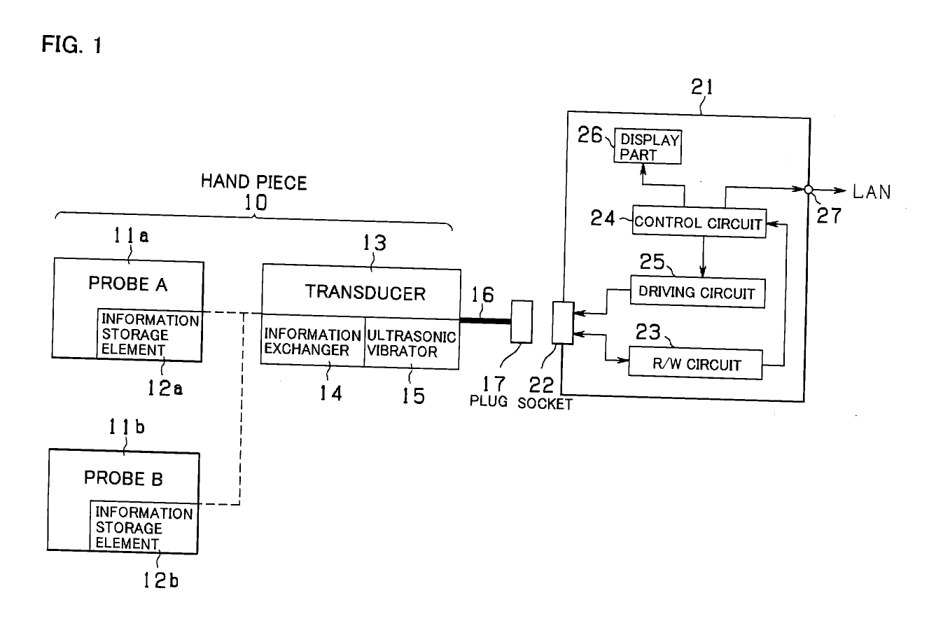

FIG. 1 is a block diagram showing a preferred construction of an ultrasonic operating apparatus according to a first embodiment of the invention. As shown in FIG. 1, the ultrasonic operating apparatus according to the first embodiment of the invention includes a hand piece 10 and a driving control device 21 for driving and controlling the hand piece 10. The hand piece 10 has a probe 11 and a transducer 13. The probe 11 is selected from among a plurality of probes such as a probe A 11a and a probe B 11b which have different therapeutic instruments, and each selected one of the probes is connected to the transducer 13 interchangeably with the others. Ultrasonic vibration is transmitted from the transducer 13 to the probe 11 (for example, the probe A 11a or the probe B 11b) connected to the transducer 13.

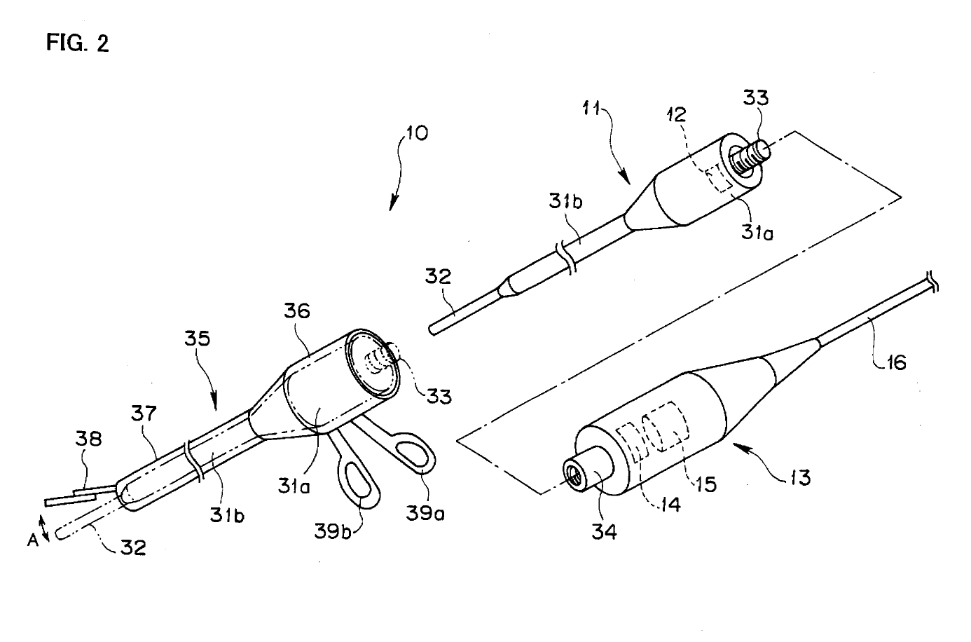

FIG. 2 is an exploded perspective view showing the construction of the external appearance of the hand piece 10 of the ultrasonic operating apparatus according to the first embodiment. FIG. 2 shows the transducer 13, the probe 11 and a control stick 35 in which the probe 11 is accommodated.

The probe 11 has a proximal probe end 31a, an elongate probe portion 31b extending from the proximal probe end 31a, and a therapeutic instrument 32 provided at the distal tip of the elongate probe portion 31b. The proximal probe end 31a is provided with an external thread portion 33 to be screwed into the transducer 13.

The probe 11 is formed of a material (for example, a titanium alloy) which can withstand stress from ultrasonic vibration. The therapeutic instrument 32 is selected from among plural kinds of therapeutic instruments having different shapes according to the kinds of living tissues to be treated and the types of operations, and there are ultrasonic vibration conditions corresponding to the respective therapeutic instruments.

Accordingly, the probe 11 is provided with an information storage element 12 (for example, an integrated circuit chip) which stores information for identifying the kind of therapeutic instrument 32 and use history information on the probe 11. For example, the probe A 11a and the probe B 11b are respectively provided with information storage elements 12a and 12b.

The transducer 13 has an ultrasonic vibrator 15 for supplying ultrasonic vibration to the probe 11 and an information exchanger 14 for writing and reading information to and from the information storage element 12 of the probe 11 in a non-contact manner.

The distal end of the transducer 13 is provided with an internal thread portion 34 into which the external thread portion 33 of the probe 11 is to be screwed. A transducer cable 16 to be connected to the driving control device 21 for driving and controlling the ultrasonic vibrator 15 and the information exchanger 14 extends from the proximal end of the transducer 13.

The probe 11 is inserted through the control stick 35 during use. The control stick 35 has a hollow form as a whole, and has a operating portion 36 and a sheath portion 37. The proximal probe end 31a and the elongate probe portion 31b of the probe 11 are respectively inserted through the operating portion 36 and the sheath portion 37, and the therapeutic instrument 32 protrudes outwardly from the distal tip of the sheath portion 37. In addition, the distal tip of the sheath portion 37 is preferably provided with a grasping portion 38, and the operating portion 36 is provided with operating handles 39a and 39b for operating the grasping portion 38.

As shown by dot-dot-dashed lines in FIG. 2, when the probe 11 is inserted through the control stick 35, the therapeutic instrument 32 protrudes from the distal tip of the sheath portion 37, the elongate probe portion 31b is fitted into the sheath portion 37, and the proximal probe end 31a is fitted into the operating portion 36. The external thread portion 33 is positioned at the end face of the proximal probe end 31a and protrudes from the control stick 35.

When the operating handles 39a and 39b provided in the operating portion 36 of the control stick 35 are operated, the grasping portion 38 is driven to move in either of the opposite directions indicated by arrow A in FIG. 2. When the grasping portion 38 is closed, a living tissue can be grasped between the grasping portion 38 and the therapeutic instrument 32′.

During the use of the ultrasonic operating apparatus according to the first embodiment, the probe 11 is inserted through the control stick 35, and the external thread portion 33 of the probe 11 is connected to the internal thread portion 34 of the transducer 13 in the state of being screwed thereinto. During this state, when the ultrasonic vibrator 15 of the transducer 13 is driven, ultrasonic vibrations generated from the ultrasonic vibrator 15 are transmitted from the proximal probe end 31a of the probe 11 to the therapeutic instrument 32 via the elongate probe portion 31b. Treatment of a living tissue grasped between the grasping portion 38 and the therapeutic instrument 32 is performed by means of the ultrasonic vibrations of the therapeutic instrument 32.

The probe 11 can be interchanged with a plurality of types of probes such as the probe A 11a and the probe B 11b according to particular treatment conditions for individual living tissues being treated.

The information storage element 12 will be described below. In recent years, integrated circuit chips which are very thin and small have been developed and put to practical use. As an example of such an integrated circuit chip, there is an integrated circuit element which can be embedded into paper and to and from which information can be written and read by radio waves. The integrated circuit element is very small like a piece of powder.

In the first embodiment, an extremely thin and small integrated circuit element to and from which various kinds of information can be written and read in such a non-contact manner is provided in the proximal end portion of the probe 11 as the information storage element 12. In addition, the information exchanger 14 which writes and stores specific information and use history information into the information storage element 12 in a non-contact manner (for example, by using radio waves) is provided in the transducer 13. Incidentally, the non-contact exchange of information between the information storage element 12 and the information exchanger 14 is not a necessary condition. Although not preferred, the information exchanger 14 can be connected to the information storage element 12 by wiring having mating connectors (not shown) in the external and internal thread portions 33 and 34.

In the non-contact configuration, the transducer 13 has the information exchanger 14 provided at a position where when the probe 11 is connected to the transducer 13, the information exchanger 14 is opposed to the information storage element 12 provided at the proximal probe end 31a of the probe 11. The driving control device 21 drives and controls the information exchanger 14 to perform control to write and read information to and from the information storage element 12.

As shown in FIG. 1, when either of the probe A 11a and the probe B 11b having different kinds of therapeutic instruments is interchangeably connected to the transducer 13, writing and reading of information can be performed between the information exchanger 14 of the transducer 13 and the information storage element 12a or 12b of the probe 11 in a non-contact manner.

The transducer cable 16 extends from the transducer 13, and a transducer plug 17 is provided at the proximal end of the transducer cable 16.

The transducer plug 17 is connected to a socket 22 of the driving control device 21. The driving control device 21 has a read/write circuit 23 for driving and controlling the information exchanger 14 of the transducer 13, a control circuit 24 for generating various kinds of control signals on the basis of information read from the read/write circuit 23, and a driving circuit 25 for driving and controlling the ultrasonic vibrator 15 on the basis of a control signal from the driving circuit 24. The driving control device 21 also has a display part 26 for displaying various kinds of information on the basis of a control signal from the control circuit 24, and a terminal 27 which connects the control circuit 24 to a LAN for information communication.

Incidentally, the read/write circuit 23 may be divided into a dedicated read circuit and a dedicated write circuit.

The control circuit 24 includes, for example, a microprocessor, and drives and controls the information exchanger 14 of the transducer 13 via the read/write circuit 23 to execute information read/write control for reading identification information on the probe 11 stored in the information storage element 12 or writing use history information on the probe 11. The control circuit 24 executes ultrasonic vibration driving control for driving and controlling the ultrasonic vibrator 15, via the driving circuit 25, on the basis of the identification information read from the information storage element 12. The control circuit 24 also performs display control for displaying on the display part 26 the use history information read from the information storage element 12, and information output control for outputting the identification information and the use history information read from the information storage element 12, to the LAN communication line connected to the terminal 27.

The action of the ultrasonic operating apparatus according to the first embodiment will be described below. First of all, an operator inputs a driving instruction by using an operation instruction input part (not shown) provided in the driving control device 21, with the transducer plug 17 of the transducer 13 connected to the socket 22 of the driving control device 21 and, for example, the probe A 11a connected to the transducer 13. Then, in response to the operation instruction input, the control circuit 24 drives and controls the information exchanger 14 of the transducer 13 via the read/write circuit 23 and performs the read processing of reading in a non-contact manner identification information and use history information on the probe A 11a which are stored in the information storage element 12a of the probe A 11a.

The read identification information and use history information are displayed on the display part 26 under the display control of the control circuit 24 as identification information indicative of the probe A 11a and use history information on the probe A 11a.

Furthermore, on the basis of the read identification information indicative of the probe A 11a, the control circuit 24 reads driving conditions suitable for the probe A 11a (which are preferably stored in a look up table accessible by the control circuit 24), and drives the ultrasonic vibrator 15 of the transducer 13 under the driving conditions suitable for the probe A 11a via the driving circuit 25 (ultrasonic vibrator driving control). In addition, the control circuit 24 drives and controls the information exchanger 14 via the read/write circuit 23 and writes use information on the probe A 11a into the information storage element 12a of the probe A 11a to update the use history information of the information storage element 12a (information read/write control).

When the probe B 11b is connected to the transducer 13 in place of the probe A 11a, the control circuit 24 detects a change in probe identification information. In the first embodiment, the control circuits 24 queries the information storage element 12 and reads the stored identification information on the probe 11 at determined intervals. Then, similarly to the case of the probe A 11a, the control circuit 24 executes processing such as reading identification information and use history information on the probe B 11b, displaying the read identification information and use history information on the display part 26, performing driving control on the ultrasonic vibrator 15 under driving conditions suitable for the probe B 11b, and writing use information on the probe B 11b into the information storage element 12b to update the use history information of the information storage element 12b.

In the first embodiment, the control circuit 24 has access to driving condition data for the ultrasonic vibrator 15 which correspond to a plurality of kinds of probes 11. The driving condition data are data arranged in a look up table format which enables data retrieval to be performed by using identification information on each of the probes as a key, and driving conditions suitable for a particular one of the probes can be retrieved from the driving condition data on the basis of identification information on the particular probe. In addition, the driving condition data for the ultrasonic vibrator 15 stored in the control circuit 24 are rewritable (for example, via a LAN) when a new probe 11 is developed and put to practical use. The look up table can be written into a section of the control circuit 24 or be separably provided and accessible by the control circuit 24.

As a matter of course, the driving condition data for the ultrasonic vibrator 15 which correspond to the plural kinds of probes 11 may be stored in a storage device on a network (for example, a LAN) so that the driving control device 21 can acquire suitable driving conditions remotely via the network. In this case, maintenance of data for probe vibration conditions can be facilitated. In addition, use history information on probes may also be stored in the storage device on the network in a linked relationship to identification information on the probes. However, when the use histories of probes are stored on a network, there is a possibility that unnecessary data may increase if the use history of a probe is not erased in synchronism with the disposal of the probe.

In addition, driving condition data for the ultrasonic vibrator 15 which correspond to the probe 11 may be stored in the information storage element 12 of the probe 11.

In the first embodiment, in this manner, it is possible to automatically set optimum driving conditions for the ultrasonic vibrator 15 of the transducer 13 which correspond to the probe 11, on the basis of the identification information stored in the information storage element 12 of the probe 11 connected to the transducer 13. Furthermore, the current use information on the probe 11 can be written and stored into the information storage element 12 at any time.

The identification information and the use history information stored in the information storage element 12 of the probe 11 can also be transferred to, for example, a central management system via the LAN communication line connected to the terminal 27 of the driving control device 21, so that management of use status, sterilization, cleaning and the like as to each of the probes 11 can be unitarily managed.

In addition, in the first embodiment, the reading/writing of information between the information storage element 12 of the probe 11 and the information exchanger 14 of the transducer 13 can be performed in a non-contact manner. Accordingly, it is possible to realize a structural form which can ensure the mechanical strength of the connection between the probe 11 and the information exchanger 14 and which is good in the efficiency of conduction of ultrasonic vibration. In the first embodiment, radio signals are used to carry out writing and reading of information to and from the information storage element 12. As a non-contact information transmission method, magnetism and light can also be used instead of radio waves. As discussed above, the “non-contact” configuration of the first embodiment is a desired condition, but is not an essential condition.

Incidentally, the information storage element 12 provided in the probe 11 may be a dedicated read element (for example, a ROM) which stores only identification information on the probes 11, and the function of updating and recording use history information may be omitted. According to this construction, it is possible to simplify the function of the information storage element 12 of the probe 11 and the information exchanger 14 of the transducer 13.

In this case, use history information can be recorded, for example, in a recording element in the control circuit 24 in the driving control device 21. In this case, with identification information on the probe 11, the use history information on the probe 11 can be specified from the use history information on each probe recorded in the recording element in the control circuit 24. Furthermore, the recorded identification information and use history information may be transferred to a centralized management system in a hospital via the LAN communication line so that the probes can be unitarily managed. As a matter of course, the use history information may also be stored not in the driving control device 21 but in the storage device on the LAN (network).

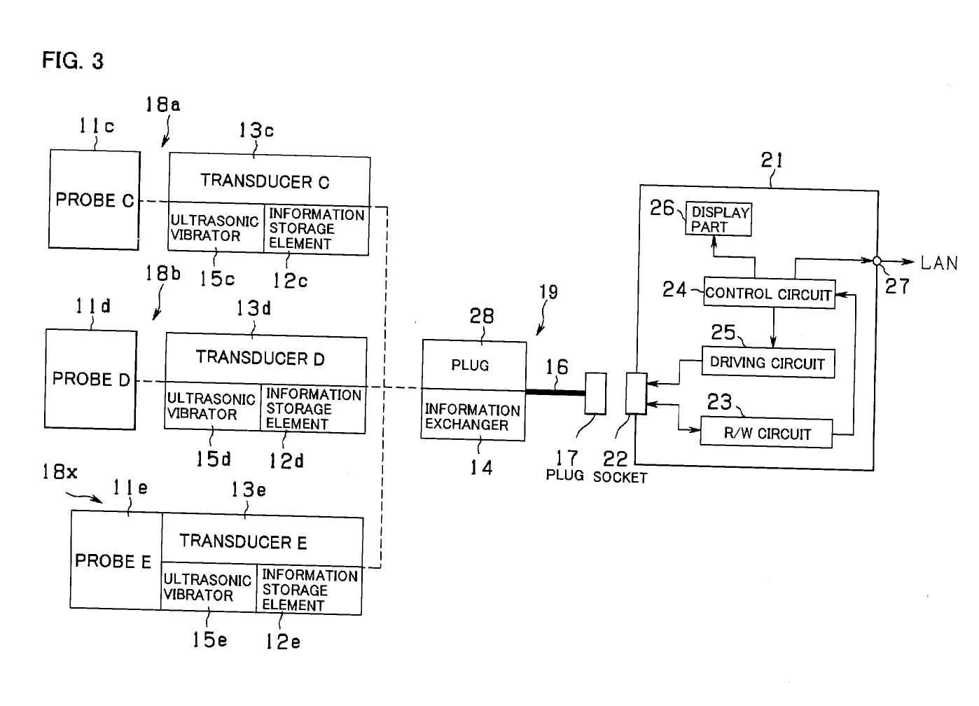

An ultrasonic operating apparatus according to a second embodiment of the invention will be described below with reference to FIG. 3. Incidentally, in FIG. 3, the same reference numerals are used to denote the same parts and portions as those shown in FIG. 1, and the detailed description of the same parts and portions should be referenced to the first embodiment.

The probes used in the second embodiment include transducer-attached type probes 18a and 18b. In the respective transducer-attached type probes 18a and 18b, different kinds of probes such as a probe C 11c and a probe D 11d are removably attachable to a dedicated transducer C 13c and a dedicated transducer D 13d. The probes used in the second embodiment further include an integrated transducer type probe 18x in which a probe E 11e and a transducer E 13e are integrated.

The transducer C 13c of the transducer-attached type probe 18a contains an ultrasonic vibrator 15c and an information storage element 12c, while the transducer D 13d of the transducer-attached type probe 18b contains an ultrasonic vibrator 15d and an information storage element 12d.

The transducer E 13e of the integrated transducer type probe 18x contains an ultrasonic vibrator 15e and an information storage element 12e.

Identification information and use history information on each of the probe C 11c, the probe D 11d and the probe E 11e are stored in a respective one of these information storage elements 12c, 12d and 12e.

The transducer-attached type probe 18a or 18b or the integrated transducer type probe 18x is connected to the driving control device 21 by a transducer connecting adapter 19.

The transducer connecting adapter 19 has a transducer interchanging plug 28. The transducers C 13c and D 13d of the transducer-attached type probes 18a and 18b and the transducer E 13e of the integrated transducer type probe 18x are interchangeably connected to the transducer interchanging plug 28. The transducer connecting adapter 19 has the transducer cable 16 extending from the transducer interchanging plug 28 and the transducer plug 17 provided at the proximal end of the transducer cable 16 and connectable to the socket 22 of the driving control device 21. The transducer interchanging plug 28 contains the information exchanger 14.

In the ultrasonic operating apparatus according to the second embodiment, the transducer-attached type probes 18a and 18b and the integrated transducer type probe 18x are interchangeably connectable to the driving control device 21 via the transducer connecting adapter 19. When the transducer-attached type probe 18a or 18b or the integrated transducer type probe 18x is connected to the transducer interchanging plug 28, identification information and use history information can be read and written from and to the information storage element 12c, 12d or 12e in a non-contact manner by the information exchanger 14.

The action of the ultrasonic operating apparatus according to the second embodiment will be described below. First of all, an operator inputs a driving instruction by using the operation instruction input part (not shown) provided in the driving control device 21, with the transducer-attached type probe 18a or 18b or the integrated transducer type probe 18x connected to the driving control device 21 via the transducer connecting adapter 19. Then, in response to the operation instruction, the control circuit 24 drives and controls the information exchanger 14 of the transducer connecting adapter 19 via the read/write circuit 23. Then, the control circuit 24 performs the processing of reading identification information and use history information on the probe C 11c, D 11d or E 11e which are stored in the information storage element 12c, 12d or 12e of the transducer-attached type probe 18a or 18b or the integrated transducer type probe 18x connected to the transducer connecting adapter 19 (information read/write control).

Then, the read identification information and use history information are displayed on the display part 26 under the display control of the control circuit 24 as identification information indicative of the connected probe 18a, 18b or 18x and use history information on the connected probe 18a, 18b or 18x.

Furthermore, on the basis of the read identification information indicative of the connected probe 18a, 18b or 18x, the control circuit 24 drives the connected probe 18a, 18b or 18x under driving conditions suitable for the connected probe 18a, 18b or 18x via the driving circuit 25 (ultrasonic vibrator driving control). In addition, the control circuit 24 drives and controls the information exchanger 14 via the read/write circuit 23 and writes the current use information into the information storage element 12c, 12d or 12e of the connected one of the transducer-attached type probes 18a and 18b and the integrated transducer type probe 18x to update the use history information of the information storage element 12c, 12d or 12e (information read/write control).

Namely, the driving circuit 25 drives one of the ultrasonic vibrators 15C, 15d and 15e on the basis of the probe identification information recorded in the information storage element 12c, 12d or 12e of the one of the transducers C 13c, D 13d and E 13e that is connected to the transducer connecting adapter 19. Furthermore, the control circuit 24 performs displaying, updating and writing on the use history information recorded in the information storage element 12c, 12d or 12e of the connected one of the transducers C 13c, D 13d and E 13e.

In addition, the identification information and the use history information stored in the information storage element 12c, 12d or 12e of the connected one of the transducer-attached type probes 18a and 18b and the integrated transducer type probe 18x are transferred to, for example, a central management system in a hospital via the LAN communication line connected to the terminal 27 of the driving control device 21, so that management of use status, sterilization, cleaning and the like as to each of the probes 11 can be unitarily managed.

In addition, in the second embodiment, the reading/writing of information can be performed in a non-contact manner between the information exchanger 14 of the transducer connecting adapter 19 and the information storage element 12c, 12d or 12e of the connected one of the transducer-attached type probes 18a and 18b and the integrated transducer type probe 18x. Accordingly, it is possible to realize a structural form which can ensure the mechanical strength of the connection between the transducer connecting adapter 19 and any of the transducer-attached type probes 18a and 18b and the integrated transducer type probe 18x and which is good in the efficiency of conduction of ultrasonic vibration.

The second embodiment has been described with reference to the example in which the two kinds of transducer-attached type probes 18a and 18b and the one kind of integrated transducer type probe 18x are interchangeably connected to the driving control device 21 via the transducer connecting adapter 19. However, the number of kinds of transducer-attached type probes 18a and 18b and integrated transducer type probe 18x are not limited to the above-described example, and can be determined as required.

The information storage elements 12c, 12d and 12e respectively provided in the transducer-attached type probes 18a and 18b and the integrated transducer type probe 18x may also be dedicated read elements (for example, ROMs) which respectively store only identification information on the probes C 11c, D 11d and E 11e. In addition, the control circuit 24 of the driving control device 21 may be provided with a storage element which stores use history information as to the use and driving of the transducers C 13c, D 13d and E 13e and driving conditions for the respective probes C 11c, D 11d and E 11e. According to this construction, it is possible to simplify the information storage elements 12c, 12d and 12e of the respective transducers C 13c, D 13d and E 13e and the function of the information exchanger 14 of the transducer interchanging plug 28. Furthermore, the driving condition information and the use history information stored in the storage element of the control circuit 24 of the driving control device 21 may be transferred to a centralized management system in a hospital via the LAN communication line so that the probes can be unitarily managed.

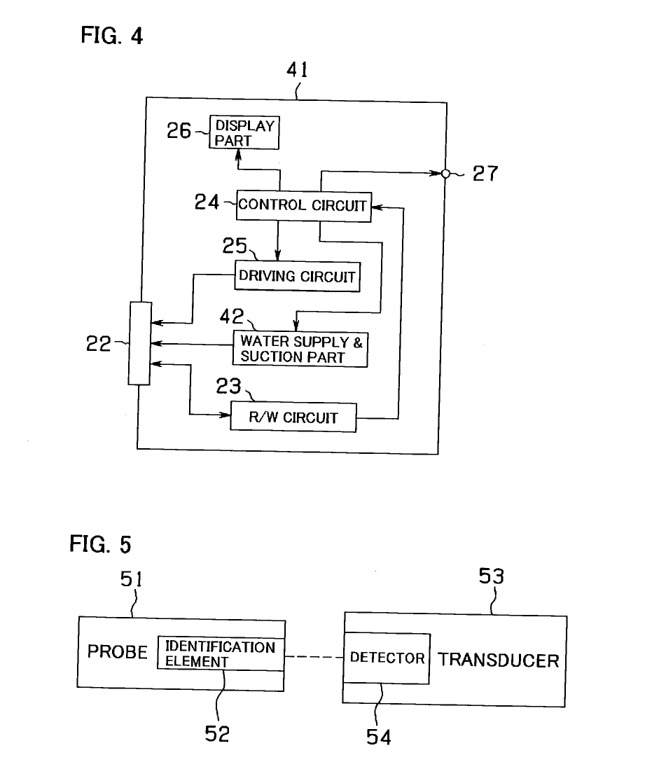

An ultrasonic operating apparatus according to a third embodiment of the invention will be described below with reference to FIG. 4. The third embodiment further includes a water supply and suction function which supplies water for cooling the heat of a probe driven by being vibrated by ultrasonic vibration and sucks and removes a living tissue broken by a therapeutic instrument during a treatment such as coagulation and incision of a living tissue by ultrasonic vibration with any of the therapeutic instruments of the ultrasonic operating apparatus according to either of the first and second embodiments.

In the ultrasonic operating apparatus having the water supply and suction function, each of the probe 11 and the transducer 13 described above in connection with FIG. 2 contains a water supply tube and a suction tube (neither of which is shown). The water supply tube and the suction tube extending from the transducer 13 are respectively connected to a water supply pump and a suction pump (neither of which is shown).

A driving control device 41 for driving and controlling the water supply pump and the suction pump to which are connected the water supply tube and the suction tube contained in each of the probe 11 and the transducer 13 will be described below with reference to FIG. 4. In FIG. 4, the same reference numerals are used to denote the same parts and portions as those shown in FIGS. 1 to 3, and the detailed description of the same parts and portions should be referenced to the first or second embodiment.

The construction of the driving control device 41 is such that the driving control device 21 is provided with a water supply and suction part 42 which controls the driving of each of the water supply pump and the suction pump. This water supply and suction part 42 is driven and controlled by the control circuit 24.

The amount of heat generation due to the ultrasonic vibration of the probe 11 differs for the forms of therapeutic instruments and probes as well as the amplitudes of ultrasonic vibrations, and the amount of heat generation increases, particularly as the amplitude of ultrasonic vibration increases. For this reason, the amount of supply of cooling water needs to be controlled according to the amplitude of ultrasonic vibration.

The ultrasonic operating apparatus according to the third embodiment is constructed to read cooling water supply amount information indicative of the amount of supply suitable for a probe from a recording part on the basis of identification information on the probe stored in the information storage element 12 to control the water supply pump and the suction pump on the basis of the information.

In the third embodiment, when driving the ultrasonic vibrator 15 via the driving circuit 25, the driving control device 41 drives and controls the above-described pumps via the water supply and suction part 42 by using the identification information stored in the information storage element 12. Namely, the value of the minimum amount of cooling water to be supplied to the probe 11 is stored in advance in a storage element of the control circuit 24 in a linked relationship to the identification information stored in the information storage element 12 of the probe 11, and the driving control device 41 drives and controls the pumps via the water supply and suction part 42 on the basis of the minimum water supply amount value stored for the identification information for each of the probes 11. Accordingly, the driving control device 41 can provide water supply control corresponding to each of the probes 11, over the minimum amount of supply of cooling water.

Otherwise, minimum water supply data indicative of the minimum cooling water supply amount for each of the probes 11 may be stored in the information storage element 12 itself. In this case, the control circuit 24 drives and controls the read/write circuit 23 of the driving control device 41 and reads the minimum cooling water supply amount data via the information exchanger 14. On the basis of this read minimum cooling water supply amount data, the control circuit 24 drives and controls the water supply and suction part 42 to provide water supply control.

Incidentally, the operator can input an operation instruction by using the operation instruction input part (not shown) as required so that the cooling water supply amount becomes not smaller than the minimum water supply amount.

Accordingly, the minimum cooling water supply amount required to cool each of the probes 11 can be automatically set according to the specifications of each of the probes 11. In addition, the operator can perform a water supply amount increasing operation with the operation instruction input part provided in the driving control device 41 only when the operator needs to supply cooling water in an amount not smaller than the minimum water supply amount.

An ultrasonic operating apparatus according to a fourth embodiment of the invention will be described below with reference to FIG. 5. In the fourth embodiment, an identification element 52 having the function of only identifying a probe 51 is provided in the probe 51 in place of the expensive information storage element 12 of high storage capacity and high function which is contained in the probe 11. The fourth embodiment provides a comparatively simple and inexpensive ultrasonic operating apparatus having a transducer 53 which contains a detector 54 for identifying and detecting the identification element 52 provided in the probe 51, preferably in a non-contact manner.

The identification element 52 provided in the probe 51 is an element capable of only identifying the probe 11, and uses, for example, a magnetic substance (for example, magnetic powder) capable of changing the magnitude of magnetic flux according to the properties and the form of the magnetic substance and sets plural kinds of identification magnetic fluxes by combining the properties and the form of the magnetic substance.

The detector 54 of the transducer 53 detects the identification magnetic flux of the identification element 52 of the probe 51, and transmits the detected identification magnetic flux to the driving control device 41.

The driving control device 41 identifies the probe 51 on the basis of the identification magnetic flux detected by the detector 54 of the transducer 53, and drives and controls the identified probe 51 under optimum ultrasonic vibration driving conditions for the probe 51.

The control circuit 24 of the driving control device 41 is provided with a storage element which temporarily stores identification result information on the probe 51 based on the identification magnetic flux detected by the detector 54 of the transducer 53, and use history information indicative of information on the driving and use of the probe 51. The identification information and the use history information which are temporarily stored in the storage element are transferred to a centralized management system in a hospital via the LAN communication line so that probes can be unitarily managed.

Accordingly, in the fourth embodiment, neither the expensive information storage element 12 of high storage capacity and high function nor the information exchanger 14 for exchanging information with the information storage element 12 is used, but the identification element 52 for simply generating only identification information and the detector 54 capable of detecting the identification information generated from the identification element 52 are employed. Accordingly, control of ultrasonic vibration can be automatically effected by the probe 51 and the transducer 53 both of which are simple and inexpensive.

In addition, since the driving control device 21, 41 stores the identification information detected by the detector 54 and the use history information as to the history of driving of the probe 51, the history of the probe 51 can also be managed.

Incidentally, the fourth embodiment has been described with reference to the example in which the probe 51 is provided with the identification element 52 and the transducer 53 is provided with the detector 54. However, as described above in connection with the second embodiment, it is apparent that the identification element 52 may be provided in the transducer 53 and the detector 54 may be provided in the transducer interchanging plug 28 of the transducer connecting adapter 19.

As is apparent from the foregoing description, in the ultrasonic operating apparatus according to any of the above-described embodiments, ultrasonic vibration conditions can be automatically set. Accordingly, operators need not perform the process of setting ultrasonic vibration conditions, and can concentrate on only operating treatments. It is also desirable that use history information be automatically written and stored into an information storage element or the like according to the use of each probe or each transducer. Furthermore, by collecting the use history information via a LAN communication line in a hospital, it is possible to facilitate unitary management of probes or transducers.

While there has been shown and described what is considered to be preferred embodiments of the invention, it will, of course, be understood that various modifications and changes in form or detail could readily be made without departing from the spirit of the invention. It is therefore intended that the invention be not limited to the exact forms described and illustrated, but should be constructed to cover all modifications that may fall within the scope of the appended claims.

What is claimed is

1. An ultrasonic operating apparatus comprising:
an ultrasonic probe;
a transducer having an ultrasonic vibrator for generating ultrasonic vibration to be transmitted to the ultrasonic probe;
an information storage part storing at least characteristic information on the ultrasonic probe; and
a control part for driving the ultrasonic vibrator under conditions suitable for the ultrasonic probe, the conditions being determined based at least in part on the characteristic information read from the information storage part.

2. An ultrasonic operating apparatus according to claim 1, wherein the information storage part stores identification information for the ultrasonic probe as the characteristic information.

3. An ultrasonic operating apparatus according to claim 2, wherein the conditions under which the control part drives the ultrasonic vibrator are stored in the control part in such a manner that the conditions correspond to the identification information.

4. An ultrasonic operating apparatus according to claim 2, wherein the conditions under which the control part drives the ultrasonic vibrator are stored on a network accessible from the control part in such a manner that the conditions correspond to the identification information.

5. An ultrasonic operating apparatus according to claim 1, wherein the information storage part stores the conditions for driving the ultrasonic probe as the characteristic information.

6. An ultrasonic operating apparatus according to claim 1, wherein the information storage part is contained in the ultrasonic probe and
wherein the transducer has an information exchanger capable of reading information stored in the information storage part, the ultrasonic probe being removably attachable to the transducer.

7. An ultrasonic operating apparatus according to claim 6, wherein the information exchanger reads in a non-contact manner the information stored in the information storage part.

8. An ultrasonic operating apparatus according to claim 7, wherein the information exchanger reads the information in the non-contact manner by using electromagnetic waves.

9. An ultrasonic operating apparatus according to claim 6, wherein the ultrasonic probe comprises two or more ultrasonic probes, each of which is removably attachable to the transducer.

10. An ultrasonic operating apparatus according-to claim 1, further comprising a connecting adapter connecting the transducer and the control part to each other,
wherein the information storage part is contained in the transducer, the transducer being dedicated to the ultrasonic probe and the connecting adapter having an information exchanger capable of reading information stored in the information storage part.

11. An ultrasonic operating apparatus according to claim 10, wherein the ultrasonic probe is removably attachable to the transducer.

12. An ultrasonic operating apparatus according to claim 10, wherein the transducer is integrated with the ultrasonic probe.

13. An ultrasonic operating apparatus according to claim 10, wherein the transducer is removably attachable to the connecting adapter.

14. An ultrasonic operating apparatus according to claim 13, wherein the transducer comprises two or more transducers, each of which is removably attachable to the connecting adapter.

15. An ultrasonic operating apparatus according to claim 10, wherein the information exchanger reads in a non-contact manner the information stored in the information storage part.

16. An ultrasonic operating apparatus according to claim 15, wherein the information exchanger reads the information in the non-contact manner by using electromagnetic waves.

17. An ultrasonic operating apparatus according to claim 1, wherein the information storage part further stores use history information for the ultrasonic probe, the control part further updating the use history information stored in the information storage part upon each subsequent use of the ultrasonic probe.

18. An ultrasonic operating apparatus according to claim 1, wherein the control part performs control to supply cooling water to the ultrasonic probe in an amount of supply determined at least in part on the characteristic information.

19. An ultrasonic operating apparatus according to claim 1, further comprising a display part,
wherein the control part displays on the display part the characteristic information read from the information storage part.

20. An ultrasonic operating apparatus according to claim 1, wherein the information storage part is an integrated circuit chip.

21. An ultrasonic operating apparatus comprising:
an ultrasonic probe;
a transducer having an ultrasonic vibrator for generating ultrasonic vibration to be transmitted to the ultrasonic probe;
an information storage part storing at least use history information on the ultrasonic probe; and
a control part for updating the use history information of the information storage part at least partly on the basis of use of the ultrasonic probe

22. An ultrasonic operating apparatus according to claim 21, wherein the information storage part is contained in the ultrasonic probe and the transducer has an information exchanger capable of reading information stored in the information storage part and of writing information into the information storage part, the ultrasonic probe being removably attachable to the transducer.

23. An ultrasonic operating apparatus according to claim 22, wherein the information exchanger, in a non-contact manner, reads the stored information from the information storage part and writes information into the information storage part

24. An ultrasonic operating apparatus according to claim 23, wherein the information exchanger reads and writes the information in the non-contact manner by using electromagnetic waves.

25. An ultrasonic operating apparatus according to claim 22, wherein the ultrasonic probe comprises two or more ultrasonic probes, each of which is removably attachable to the transducer.

26. An ultrasonic operating apparatus comprising:
an ultrasonic probe;
a transducer having an ultrasonic vibrator for generating ultrasonic vibration to be transmitted to the ultrasonic probe;
an information storage part for storing at least identification information on the ultrasonic probe; and
a control part for updating, at least partly on the basis of use of the ultrasonic probe, use history information for the ultrasonic probe identified by the identification information read from the information storage part, the use history information being stored in the control part.

27. An ultrasonic operating apparatus comprising:
an ultrasonic probe;
a transducer having an ultrasonic vibrator for generating ultrasonic vibration to be transmitted to the ultrasonic probe;
an information storage part for storing at least identification information on the ultrasonic probe; and
a control part for updating, at least partly on the basis of use of the ultrasonic probe, use history information for the ultrasonic probe identified by the identification information read from the information storage part, the use history information being stored in a device on an accessible network.

28. A control device of an ultrasonic operating apparatus comprising:
a reading circuit for reading characteristic information on a connected ultrasonic probe; and
a driving circuit for driving an ultrasonic vibrator supplying ultrasonic vibration to the ultrasonic probe, under driving conditions determined on the basis of the read characteristic information on the ultrasonic probe.

29. A control device of an ultrasonic operating apparatus according to claim 28, further comprising a control circuit, wherein the characteristic information on the ultrasonic probe read by the reading circuit is identification information on the ultrasonic probe, the control circuit retrieving driving conditions for the ultrasonic probe from recorded driving conditions for a plurality of ultrasonic probes on the basis of the identification information.

30. A control device of an ultrasonic operating apparatus according to claim 29, wherein the driving conditions for the plurality of ultrasonic probes are stored in the control device.

31. A control device of an ultrasonic operating apparatus according to claim 29, wherein the driving conditions for the plurality of ultrasonic probes are stored in a device on an accessible network.

32. A control device of an ultrasonic operating apparatus comprising:
a circuit for driving an ultrasonic vibrator supplying ultrasonic vibration to a connected ultrasonic probe; and
a circuit for updating use history information for the ultrasonic probe.

33. A probe for ultrasonic operation comprising:
an information storage part for storing characteristic information on the probe, contents stored in the information storage part being externally readable.

34. A probe for ultrasonic operation according to claim 33, wherein the characteristic information stored in the information storage part contains identification information on the ultrasonic probe.

35. A probe for ultrasonic operation according to claim 33, wherein the characteristic information stored in the information storage part contains use history information for the ultrasonic probe, contents to be stored being externally writable into the information storage part.

36. A probe for ultrasonic operation according to claim 33, wherein the information storage part stores information readable in a non-contact manner.

37. A probe for ultrasonic operation according to claim 36, wherein the information storage part is an integrated circuit.

38. A dedicated ultrasonic transducer for use with a probe, the dedicated ultrasonic transducer comprising:
an information storage part for storing characteristic information for the probe, contents stored in the information storage part being externally readable.

39. A dedicated ultrasonic transducer according to claim 38, wherein the characteristic information stored in the information storage part contains characteristic information for the probe.

40. A dedicated ultrasonic transducer according to claim 38, wherein the characteristic information stored in the information storage part contains use history information for the probe, contents to be stored in the information storage part being externally writable.

41. A dedicated ultrasonic transducer according to claim 38, wherein the information storage part has information readable in a non-contact manner.

42. A dedicated ultrasonic transducer according to claim 41, wherein the information storage part is an integrated circuit chip.

43. A dedicated ultrasonic transducer according to claim 38, wherein the probe is removably attachable to the transducer.

44. A dedicated ultrasonic transducer according to claim 38, wherein the probe is fixed to the transducer.

45. A method of driving an ultrasonic operating apparatus comprising:
reading identification information for a probe from an information storage element corresponding to the probe; and
driving an ultrasonic vibrator for giving ultrasonic vibration to the probe, under conditions determined based at least partly on the identification information.

46. A method of driving each of plural kinds of probes under conditions suitable for each of the plural kinds of probes in an ultrasonic operating apparatus to which the plural kinds of probes are removably attachable, comprising:
reading in a non-contact manner identification information for a probe attached to the ultrasonic operating apparatus, the identification information being stored in an integrated circuit chip contained in one of the probe and a dedicated transducer of the probe;
reading driving conditions for the probe from stored driving conditions corresponding to the respective plural kinds of probes, based at least partly on the read identification information; and
driving the probe under the read driving conditions.

47. A method of driving an ultrasonic operating apparatus comprising:
reading use history for a probe from an information storage element corresponding to the probe; and
updating the use history for the probe on the information storage element on the basis of use of the probe.
